(19) United States
(12) Patent Application Publication
(10) Pub. No.: US 2003/0223001 A1
(43) Pub. Date: Dec. 4, 2003

(54) Image capturing apparatus

(75) Inventors: Toshihisa Maeda, Sakai-shi (JP); Tsutomu Honda, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/443,997

(22) Filed: May 22, 2003

(30) Foreign Application Priority Data
May 31, 2002 (JP) 2002-158861

(51) Int. Cl. H04N 5/335

(52) U.S. Cl. 348/273

(57) ABSTRACT

The light receiving portion of the CCD is divided into three fields. After shooting is finished, the image data of a first field is read out first. Then, when the image data of a second field is read out, AE and WB correction values are calculated based on the image data of the first field. When the image data of a third field is read out, correction is performed based on the calculated AE and WB correction values. Then, the image data of the first and the second fields are processed based on the AE and WB correction values. With this, image processing can be swiftly performed with respect to the AE and WB corrections. Moreover, since image processing is performed not based on information obtained prior to shooting but based on information (image data) obtained at the time of shooting, image processing can be appropriately performed irrespective of changes in shooting condition.

This application is based on the application No. 2002-158861 filed in Japan, the contents of which are hereby incorporated by reference.

### BACKGROUND OF THE INVENTION

1. Field of the Invention

The present invention relates to an image capturing apparatus in which the pixel arrangement of the light receiving portion having a color filter is divided into a plurality of fields each including components of all the colors of the color filter and charge signals accumulated at the time of shooting can be read out field by field.

2. Description of the Related Art

In recent years, the number of pixels of the light receiving portions of digital cameras has been rapidly increasing. On the other hand, in order that the overall size of the light receiving portion does not increase according to the number of pixels, the light receiving area of the unit light receiving elements (unit CCD cells) is reduced as the pixel density of the light receiving portion increases. Consequently, the image capture sensitivity decreases. To prevent this reduction in sensitivity, a technique is known of reducing the area of the charge transfer path that does not contribute to the photoelectric conversion function. However, when the area of the charge transfer path is reduced, it is difficult to parallelly read out the charge signals on all the lines of the light receiving portion at a time. To solve this problem, a method is adopted such that the light receiving portion is divided into a plurality of fields and the charge signals of all the pixels are sequentially read out field by field.

Japanese Laid-Open Patent Applications Nos. 2000-308075 and H10-327354 disclose a method such that with the fragmentation of the function of the image sensor, a plurality of fields is read out based on a relationship between TV scanning and the number of pixels.

As described above, for image capturing apparatuses typified by digital cameras, the method of dividing the light receiving portion into a plurality of fields and reading out the image signals of all the pixels field by field (hereinafter, referred to as “field-sequential all pixel readout method”) is adopted from various objects. Further, it is conceivable that a method will expand such that a frame is divided into not only two or three fields but also a larger number of fields (N fields where N is a given integer equal to or greater than 2) as the number of fields corresponding to one frame and all the pixels are read out.

In conventional image sensors of a two-field readout type, it is impossible to read out adjoining pixel lines as image signals of the same field. Therefore, in the case of color filters adopting the Bayer arrangement, it is impossible to obtain color information of all the colors only with a first field image or a second field image as shown in FIGS. 12(a), 12(b), 13(a) and 13(b). Consequently, to obtain color information of all the colors for performing AE (automatic exposure) correction and WB (white balance) correction, the following methods are necessary: (1) Color information of all the colors is obtained prior to actual shooting by use of another readout mode (for example, high-speed readout mode of thinning out readout lines in the vertical direction as shown in FIG. 14 and obtaining information of all the colors); or (2) after the readout of the image data of all the fields is finished, information of all the colors is obtained from the image data.

However, according to the all color information obtaining methods as described above, AE and WB corrections and swift processing in response to changes in shooting condition are difficult. That is, according to the obtaining method of (1), since the AE and WB correction amounts at the time of shooting are determined based on the color information obtained prior to shooting, it is difficult to handle shooting under a flickering light source such as a fluorescent lamp or a mercury lamp and a case where the light source condition differs between prior to shooting and after shooting such as flash shooting. According to the obtaining method of (2), although changes in shooting condition can be handled, in an image capturing apparatus having a high-pixel image sensor, after all the image data is read out from the image sensor, color information necessary for AE and WB corrections is obtained and corrections are performed. Therefore, the time from shooting to the completion of the corrections is long, so that instantaneity is impaired. This problem is more significant as the number of pixels of the image sensor increases.

### SUMMARY OF THE INVENTION

To solve the above-mentioned problems, an object of the present invention is to provide an image capturing apparatus capable of appropriately and swiftly performing image processing irrespective of changes in shooting condition.

In order to achieve the object, an image capturing apparatus according to the present invention comprises: an image sensor in which a light receiving portion having a color filter is provided; a reader for dividing a pixel arrangement of said light receiving portion of said image sensor into a plurality of fields, and reading out charge signals from said image sensor field by field; an image processor for performing predetermined image processing on image data corresponding to the charge signals read out by said reader; and a calculator for calculating a processing parameter used for said predetermined image processing by said image processor based on image data corresponding to the charge signals of a first field from which the charge signals are read out first.

According to the present invention, since processing parameters used for predetermined image processing are calculated based on the image data corresponding to the charge signals of the first field including components of all the colors, image processing can be appropriately and swiftly performed irrespective of changes in shooting condition.

In the following description, like parts are designated by like reference numbers throughout the several drawings.

### BRIEF DESCRIPTION OF THE DRAWINGS

FIG. 1 is a perspective view showing an image capturing apparatus 1A according to a first embodiment of the present invention;

FIG. 2 is a rear view of the image capturing apparatus 1A;

FIG. 3 is a view showing function blocks of the image capturing apparatus 1A;

FIG. 4 is a view of assistance in explaining the flow of image signals in the image capturing apparatus 1A;

FIGS. 5(a) to 5(c) are views of assistance in explaining a method of reading out charges from a CCD 2;

FIG. 6 is a flowchart of assistance in explaining the basic operation of the image capturing apparatus 1A;

FIG. 7 is a view of assistance in explaining the operation of the image capturing apparatus 1A;

FIG. 8 is a view showing function blocks of an image capturing apparatus 1B according to a second embodiment of the present invention;

FIG. 9 is a view of assistance in explaining the operation of an image capturing apparatus 1B;

FIG. 10 is a view of assistance in explaining the flow of image signals in an image capturing apparatus 1C according to a third embodiment of the present invention;

FIGS. 11(a) and 11(b) are views of assistance in explaining a CCD charge readout method according to a modification of the present invention;

FIGS. 12(a) and 12(b) are views of assistance in explaining the CCD charge readout method according to the prior art;

FIGS. 13(a) and 13(b) are views of assistance in explaining the CCD charge readout method according to the prior art; and

FIG. 14 is a view of assistance in explaining the high-speed readout mode of the CCD according to the prior art.

### DETAILED DESCRIPTION OF THE PREFERRED EMBODIMENTS

<First Embodiment>

<Structure of Relevant Part of Image Capturing Apparatus>

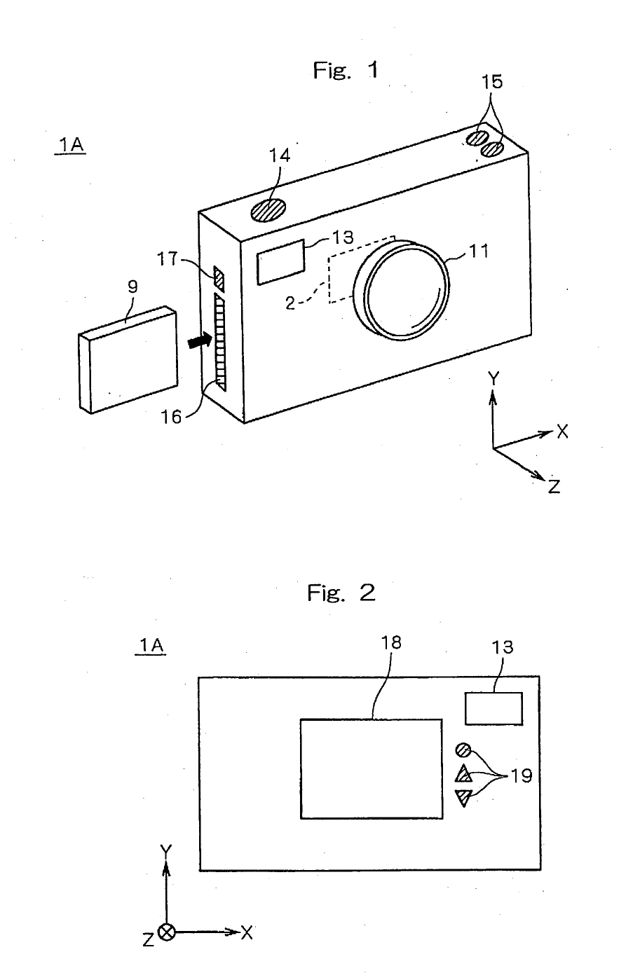

FIG. 1 is a perspective view showing an image capturing apparatus 1A according to a first embodiment of the present invention. FIG. 2 is a rear view of the image capturing apparatus 1A. In FIGS. 1 and 2, three axes X, Y and Z orthogonal to one another are shown for clarification of the directional relationship.

A taking lens 11 and a finder window 13 are provided on the front of the image capturing apparatus 1A. A CCD (charge coupled device) 2 as an image sensor photoelectrically converting subject images incident through the taking lens 11 to thereby generate image signals is provided inside the taking lens 11.

The taking lens 11 includes a lens system that can be driven in the direction of the optical axis. The subject image formed on the CCD 2 can be brought into in-focus state by driving the lens system in the direction of the optical system.

A shutter button 14 and a mode switching button 15 are disposed on the top of the image capturing apparatus 1A. The shutter button 14 is a button which the user depresses to instruct the image capturing apparatus 1A to perform shooting when shooting a subject.

The mode switching button 15 is a button for switching of modes such as a shooting mode and a playback mode.

A slot 16 for inserting a memory card 9 for recording image data obtained by shooting is formed on a side of the image capturing apparatus 1A. Further, a card extraction button 17 depressed when the memory card 9 is extracted from the slot 16 is disposed. The memory card 9 can be extracted from the slot 16 by operating the card extraction button 17.

A liquid crystal display (LCD) 18 for live view display of displaying the subject in the form of a moving image prior to actual shooting and display of shot images is provided on the rear of the image capturing apparatus 1A. Moreover, operation buttons 19 for changing the setting conditions of the image capturing apparatus 1A such as the shutter speed and a finder window 13 are provided on the rear of the image capturing apparatus 1A.

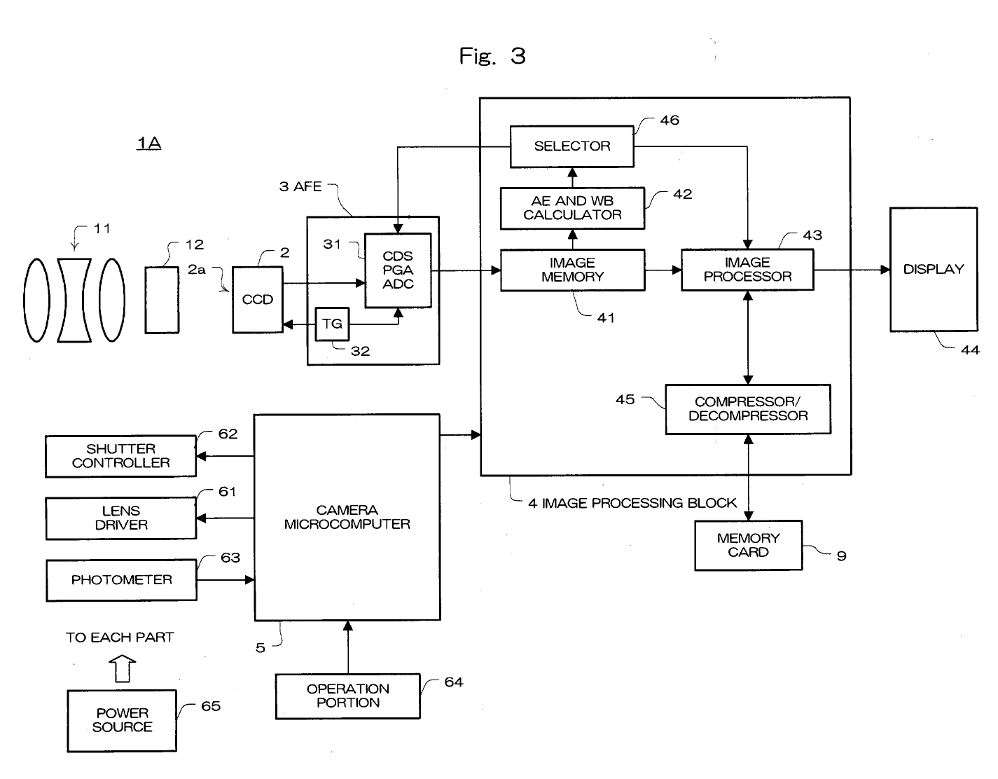

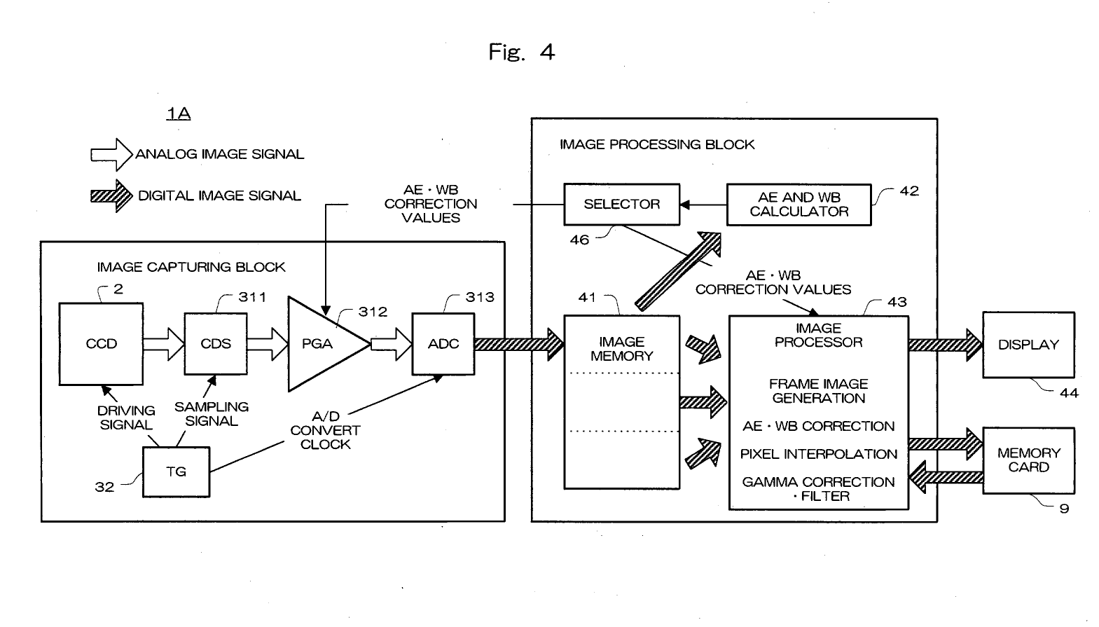

FIG. 3 is a view showing function blocks of the image capturing apparatus 1A. FIG. 4 is a view of assistance in explaining the flow of image signals in the image capturing apparatus 1A.

The image capturing apparatus 1A has: an AFE (analog front end) 3 connected to the CCD 2 so that data transmission can be performed; an image processing block 4 connected to the AFE 3 so that data transmission can be performed; and a camera microcomputer 5 performing centralized control of these elements.

The CCD 2 has a light receiving portion 2a on the surface opposed to the taking lens 11, and a plurality of pixels is arranged on the light receiving portion 2a. The pixel arrangement constituting the light receiving portion 2a is divided into three fields, and the charge signals (image signals) accumulated at the pixels can be sequentially read out field by field.

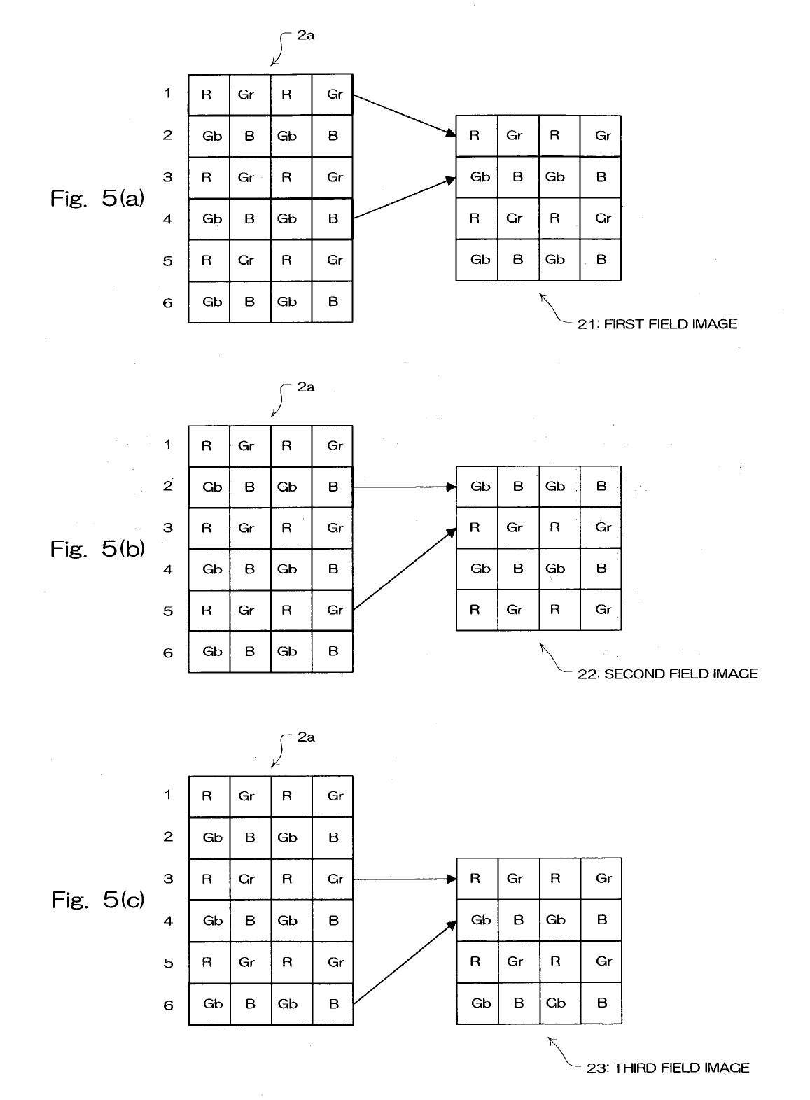

FIGS. 5(a) to 5(c) are views of assistance in explaining a method of reading out charges from the CCD 2. In actuality, not less than several millions of pixels are arranged. FIGS. 5(a) to 5(c) show only part of them for convenience of illustration.

A color filter corresponding to the pixel arrangement is provided in the light receiving portion 2a. This color filter comprises periodically distributed red (R), green (Gr, Gb) and blue (B) filters, that is, three kinds of color filters having different colors from one another.

To read out the charge signals accumulated in the cells of the CCD 2, first, as shown in FIG. 5(a), the charge signals in the first, the fourth, the seventh, . . . lines, that is, in the (3n+1)-th lines (n is an integer) are read out in the light receiving portion 2a to constitute a first field image 21. Then, as shown in FIG. 5(b), the charge signals in the second, the fifth, the eighth, . . . lines, that is, in the (3n+2)-th lines are read out in the light receiving portion 2a to constitute a second field image 22. Lastly, as shown in FIG. 5(c), the charge signals in the third, the sixth, the ninth, . . . lines, that is, in the 3n-th lines are read out in the light receiving portion 2a to constitute a third field image 23. By this charge readout method, the first to the third fields 21 to 23 each include components of all the colors of the color filter, that is, pixels of all of R, G and B.

Reverting to FIGS. 3 and 4, description will be continued.

The AFE 3 is an LSI (large-scale integrated circuit) having a signal processor 31 and a TG (timing generator) 32 transmitting a timing signal to the signal processor 31. The TG 32 transmits a CCD driving signal to the CCD 2, and a charge signal is output from the CCD 2 in synchronism with the driving signal.

The signal processor 31 has a CDS (correlated double sampler) 311, a PGA (programmable gain amplifier) 312 serving as an amplifier, and an ADC (A/D converter) 313. The output signals of the fields output from the CCD 2 are sampled by the CDS 311 based on a sampling signal from the TG 32, and are amplified to desired values by the PGA 312. The amplification factor of the PGA 312 can be changed by numerical data through a serial communication from the camera microcomputer 5. The PGA 312 also corrects image signals based on the AE and WB correction values transmitted from a selector 46. The analog signals amplified by the PGA 312 are converted into digital signals by the ADC 313, and then, transmitted to the image processing block 4.

The image processing block 4 has an image memory 41; an AE and WB calculator 42 connected to the image memory 41 so that data communication can be performed; an image processor 43; and a compressor/decompressor 45.

The image memory 41 comprises, for example, a semiconductor memory, and temporarily stores the image data of the fields 21 to 23 converted into digital form by the ADC 313. After stored into the image memory 41, the image data of all the fields is transmitted to the image processor 43 to generate one image of all the pixels. The image data of the first field 21 is also transmitted to the AE and WB calculator 42 immediately after stored into the image memory 41.

The AE and WB calculator 42 calculates AE and WB correction values based on the image data of the first field 21 transmitted from the image memory 41 (detailed later). The calculated AE and WB correction values are transmitted to the selector 46. The selector 46 transmits the AE and WB correction values to the signal processor 31 or the image processor 43 in accordance with the field readout condition of the CCD 2.

The image processor 43 interpolates the image data transmitted from the image memory 41 based on the color filter characteristic of the CCD 2. Further, the image processor 43 generates one frame image by synthesizing the image data of the fields 21 to 23. Moreover, the image processor 43 performs various image processings such as gamma correction for obtaining a natural gradation and filtering for performing edge enhancement and chroma adjustment. Further, the image processor 43 performs AE and WE corrections for adjusting the brightness and the color balance of the image data based on the AE and WE correction values transmitted from the selector 46.

A display 44 has the LCD 18, and performs image display based on the image data obtained by the CCD 2.

The compressor/decompressor 45 compresses the image data processed by the image processor 43, for example by the JPEG method, and stores it onto the memory card 9 which is a recording medium. Moreover, the compressor/decompressor 45 decompresses the image data stored on the memory card 9 for playback display by the display 44.

Moreover, the image capturing apparatus 1A has a lens driver 61, a shutter controller 62, a photometer 63, an operation portion 64 and a power source 65 connected to the camera microcomputer 5, respectively.

The lens driver 61 is for changing the position of the taking lens 11. Automatic focusing and zooming can be performed by the lens driver 61.

The shutter controller 62 is a part for opening and closing a mechanical shutter (hereinafter, referred to simply as “shutter”) 12.

The photometer 63 has a photometric sensor, and performs metering associated with the subject.

The operation portion 64 comprises various kinds of operation members such as the shutter button 14, the mode switching button 15 and the operation buttons 19.

The power source 65 has a battery, and supplies power to the parts of the image capturing apparatus 1A.

The camera microcomputer 5 has a CPU and a memory, and performs centralized control of the parts of the image capturing apparatus 1A.

<Processing of the AE and WB Calculator 42>

The AE and WB calculator 42 calculates an AE correction value (brightness correction value) and WB correction values as image processing parameters based on the image data of the first field 21 transmitted from the image memory 41 as described above. The calculation method will be described below.

1. Method of Calculating WB Correcting Values

First, a weighted average of each pixel data of the first field 21 is obtained by the following expression (1):

$$( {\overline{R}}_{wb} , \overline{G} {r}_{wb} , \overline{G} {b}_{wb} , {\overline{B}}_{wb} ) = ( \frac{{\sum }_{v} {\sum }_{h} {K}_{vh} {R}_{vh}}{v \times h} , \frac{{\sum }_{v} {\sum }_{h} {K}_{vh} {Cr}_{vh}}{v \times h} , \frac{{\sum }_{v} {\sum }_{h} {K}_{vh} {Gb}_{vh}}{v \times h} , \frac{{\sum }_{v} {\sum }_{h} {K}_{vh} {B}_{vh}}{v \times h} ) \qquad ( 1 )$$

Here, the subscripts v and h represent the numbers of pixels, in the horizontal and the vertical directions, of the first field 21. The coefficient k is a coefficient for adjusting the light ray condition such as frontlight, backlight and the color bias condition. The coefficient k can be changed according to the condition. It is preferable that the weighted average calculation be performed not based on all the pixels of the first field 21 but based on data of pixels thinned out in a predetermined distribution to reduce the calculation amount.

Then, WB correction values gr and gb are calculated by the following expression (2) based on the weighted averages of the pixels of R, Gr, Gb and B calculated by the expression (1):

$$( g r , g b ) = ( \frac{\overline{G} {r}_{wb} + \overline{G} {b}_{wb}}{2 {\overline{R}}_{wb}} , \frac{\overline{G} {r}_{wb} + \overline{G} {b}_{wb}}{2 {\overline{B}}_{wb}} ) \qquad ( 2 )$$

While a calculation method for the CCD 2 having a primary color filter is described above, in the case of a complementary color filter, the WB correction values are calculated by converting pixel outputs of G, Mg, Ye and Cy into R, Gr, Gb and B data and applying the expressions (1) and (2).

2. Method of Calculating AE Correction Value

First, like the above-described calculation of the WB correction values, a weighted average of each pixel of the first field 21 is obtained by the expression (3) shown below. In this case, a coefficient m different from the coefficient k of the expression (1) is used, and the pixel outputs of R and B are multiplied by the WB correction values gr and gb previously calculated by the expression (2).

$$( {\overline{R}}_{ae} , \overline{G} {r}_{ae} , \overline{G} {b}_{ae} , {\overline{B}}_{ae} ) = ( g r \frac{{\sum }_{v} {\sum }_{h} {m}_{vh} {R}_{vh}}{v \times h} , \frac{{\sum }_{v} {\sum }_{h} {m}_{vh} {Cr}_{vh}}{v \times h} , \frac{{\sum }_{v} {\sum }_{h} {m}_{vh} {Gb}_{vh}}{v \times h} , g b \frac{{\sum }_{v} {\sum }_{h} {m}_{vh} {B}_{vh}}{v \times h} ) \qquad ( 3 )$$

Next, a brightness signal component Y is obtained by the following expression (4) based on the weighted averages obtained by the expression (3):

$$Y = 0.299 {\overline{R}}_{a e} + 0.587 ( \frac{\overline{G} {r}_{ae} + \overline{G} {b}_{ae}}{2} ) + 0.114 {\overline{B}}_{ae} \qquad ( 4 )$$

When the reference brightness level is set to Y0, an AE correction value α can be calculated by the following expression (5):

$$α = \frac{{Y}_{0}}{Y} \qquad ( 5 )$$

In the case of a CCD having a complementary filter, the brightness signal component Y is obtained by the average of the pixel outputs of G, Mg, Ye and Cy.

<Operation of the Image Capturing Apparatus 1A>

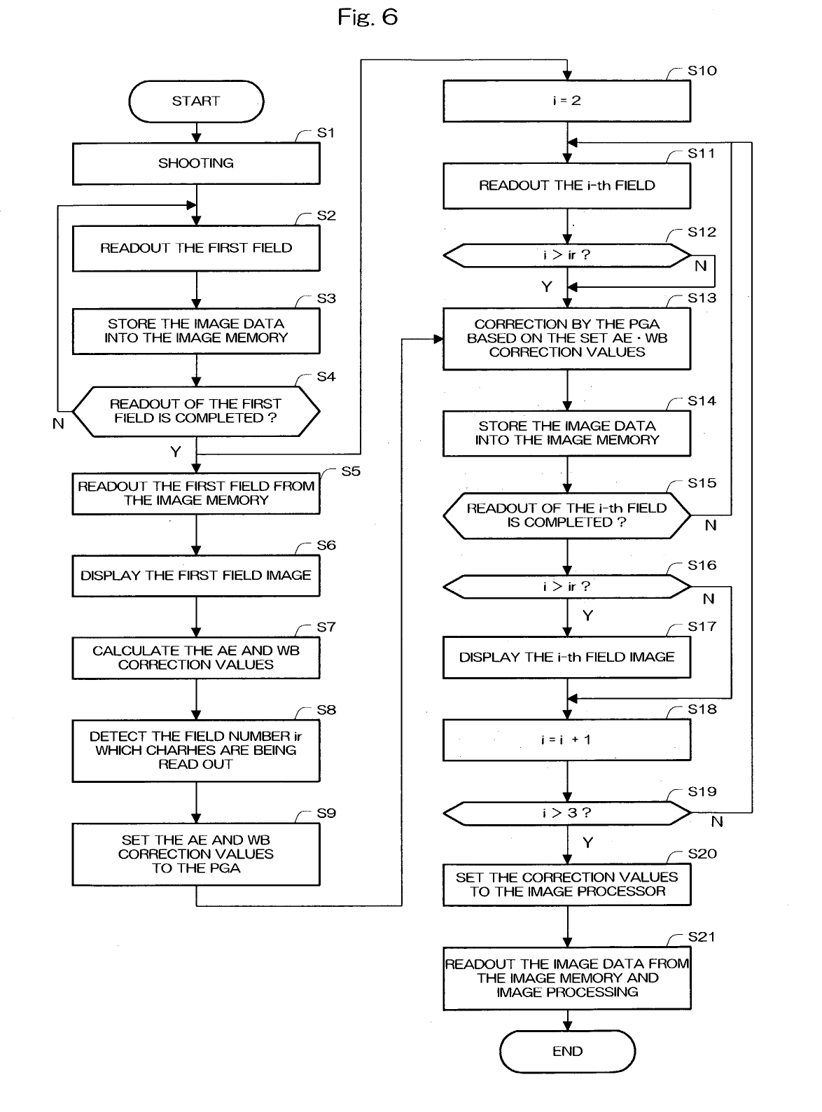

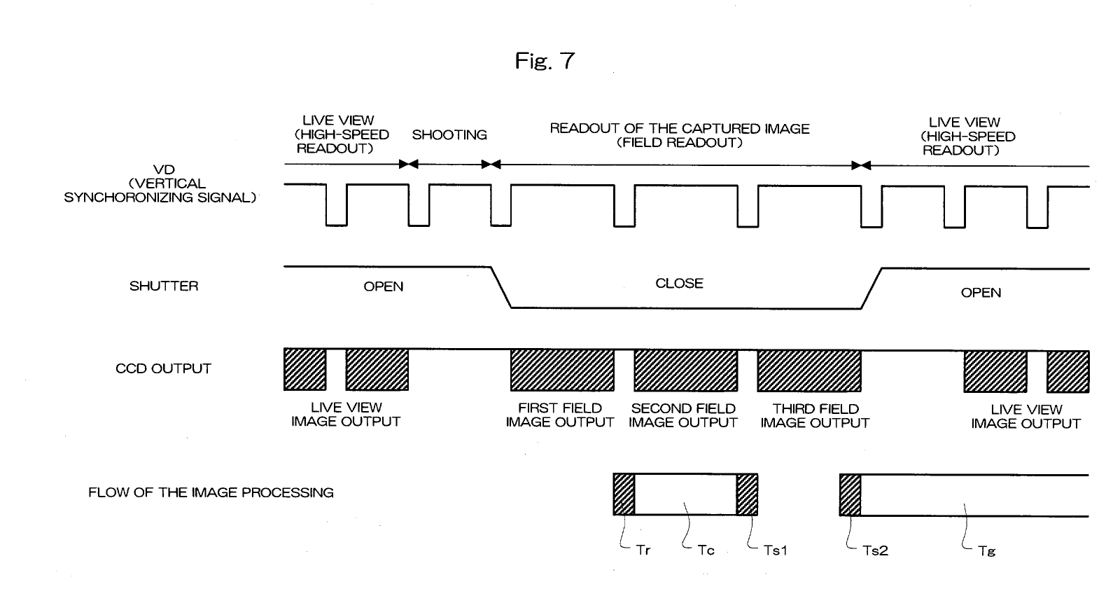

FIG. 6 is a flowchart of assistance in explaining the basic operation of the image capturing apparatus 1A. This operation is performed by the camera microcomputer 5. FIG. 7 which is a view of assistance in explaining the operation of the image capturing apparatus 1A is a timing chart showing a vertical synchronizing signal VD, the shutter 11, the output of the CCD 2 and the image processing. The flowchart of FIG. 6 will be described with reference to FIG. 7.

First, live view shooting is performed with the shutter 12 opened, and the live view image obtained by the CCD2 is displayed on the display 44. Then, when the shutter button 14 is depressed by the user, shooting is performed (step S1).

When shooting is finished, the image data of the first field 21 accumulated in the CCD 2 is read out with the shutter 12 closed (step S2).

At step S3, the image data of the first field 21 read out at step S2 is stored into the image memory 41.

At step S4, it is determined whether the readout of the image data of the first field 21 is completed or not. When the readout is completed, the process proceeds to step 5 and step 10. When the readout is not completed, the process returns to step S2.

At step S5, the image data of the first field 21 stored into the image memory 41 at step S3 is read out. As shown in FIG. 7, a readout operation Tr is performed from the completion of the readout of the image data of the first field 21.

At step S6, the display 44 performs image display based on the image data of the first field 21 read out at step S5. With this, the shot image can be swiftly displayed.

At step S7, the AE and WB calculator 42 calculates the AE and WB correction values based on the image data of the first field 21 read out at step S5. As shown in FIG. 7, a calculation processing Tc is performed immediately after the completion of the readout operation Tr. The calculation processing Tc is performed in parallel with the readout of the second field 22 from the CCD 2. By thus performing parallel processing, the correction at step S13 described later can be performed without any trouble by a calculation capability of the AE and WE calculator 42 that can complete the calculation by the time the readout of the second field 22 is completed.

At step S8, the field number ir of the field from which charges are being read out at the time of completion of the calculation processing Tc is detected. In the case of FIG. 7, the field number ir of the field from which charges are being read out is 2.

At step S9, the AE and WB correction values calculated at step S7 are set to the PGA 312. As shown in FIG. 7, a setting operation Ts1 is performed immediately after the completion of the calculation of the AE and WB correction values. With this, the image data of the field subsequent to the field of the field number ir detected at step S8 can be corrected by the PGA 312.

At step S10, 2 is assigned to a variable i.

At step S11, the image data of the i-th field is read out from the CCD 2.

At step S12, it is determined whether the variable i is higher than the field number ir detected at step S8 or not. When i>ir, the process proceeds to step S13. When i≦ir, the process proceeds to step S14. When i≦ir, unlike step S13, correction based on default values is performed by the PGA 312.

At step S13, the PGA 312 performs correction based on the AE and WB correction values set at step S9. In the case of FIG. 7, the image data of the third field 23 read out after the setting operation Ts1 is corrected. That is, the PGA 312 performs image processing on the image data of a predetermined field (third field) of the fields other than the first field. With this, the AE and WB corrections on the shot image can be started earlier, so that the correction is completed earlier, that is, image processing can be swiftly performed.

At step S14, the image data of the i-th field is stored into the image memory 41.

At step S15, it is determined whether the readout of the image data of the i-th field is completed or not. When the readout is completed, the process proceeds to step S16. When the readout is not completed, the process returns to step S11.

At step S16, it is determined whether the variable i is higher than the field number ir detected at step S8 or not. When i>ir, the process proceeds to step S17. When i≦ir, the process proceeds to step S18.

At step S17, the display 44 performs image display based on the image data of the ir-th field read out at step S11. Specifically, instead of the image of the first field 21 displayed at step S6, the image of the third field 23 is displayed. With this, the image data having undergone the AE and WB corrections by the PGA 312 can be swiftly displayed on the display 44.

At step S18, i+1 is assigned to the variable i.

At step S19, it is determined whether the variable i is higher than 3 or not. When i>3, the process proceeds to step S20. When i≦3, the process returns to step S11.

At step S20, the AE and WB correction values calculated at step S7 is set to the image processor 43. As shown in FIG. 7, an AE and WB correction value setting operation Ts2 is performed prior to an image processing Tg performed at step S21.

At step 21, the image data is read out from the image memory 41, and image processing is performed by the image processor 43. AE and WB corrections on the image data of a field subsequent to the (ir+1)-th field, that is, the third field 23 has been performed at step S13. Therefore, at step S21, correction based on the AE and WB correction values set at step S20 is performed on the image data of the other fields, that is, the first and the second fields 21 and 22. That is, the image processor 43 performs image processing on the image data of the remaining fields (the first and the second fields) other than the third field.

When the operation at step S21 is finished, the image data having undergone the image processing is displayed on the display 44, and is stored onto the memory card 9.

By the above-described operation of the image capturing apparatus 1A, the image data of the third field before stored into the image memory is corrected based on the AE and WB correction values calculated from the image data of the first field, so that image processing is swiftly performed. Moreover, since correction is performed based on the image data obtained at the time of shooting, image processing can be appropriately performed irrespective of changes in shooting condition such as a flicker of a fluorescent lamp.

<Second Embodiment>

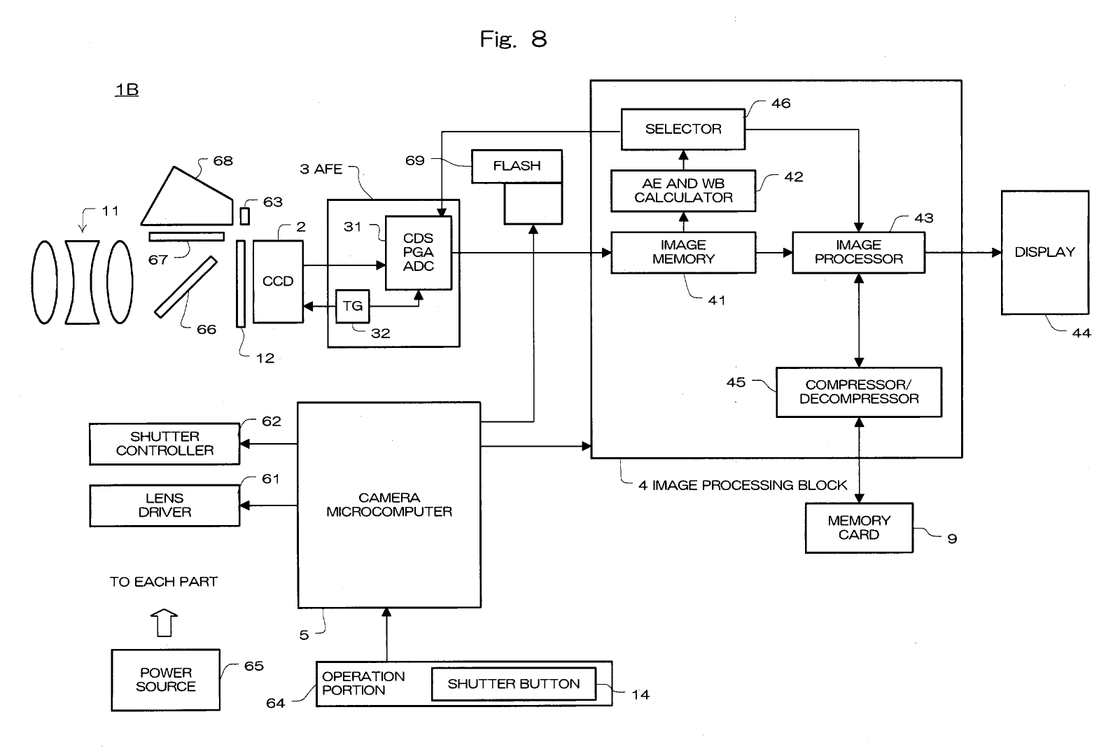

FIG. 8 is a view showing function blocks of an image capturing apparatus 1B according to a second embodiment of the present invention.

The image capturing apparatus 1B is structured as an image capturing apparatus of a type having an optical reflex viewfinder (hereinafter, referred to as “SLR type”). That is, a mirror 66, a focusing screen 67 and a prism 68 are added to the image capturing apparatus 1A of the first embodiment shown in FIG. 3. The image capturing apparatus 1B also has a flash 69.

In FIG. 8, the same function blocks as those of the first embodiment are denoted by the same reference numbers and descriptions thereof are omitted.

The mirror 66 is in a regular position inclined 45 degrees to the optical axis as shown in FIG. 8 until the shutter button 14 is fully depressed by the user, and directs the light image from the taking lens 11 toward the focusing screen 67. That is, the mirror 66, the focusing screen 67 and the prism 68 constitute an optical viewfinder. In the vicinity of the prism 68, a photometric portion 63 is provided.

When the shutter button 14 is fully depressed by the user, the mirror 66 is pivoted upward to a substantially horizontal position, so that the optical path from the taking lens 11 is opened.

A program for performing the operation described below is stored in the camera microcomputer 5 of the image capturing apparatus 1B.

<Operation of the Image Capturing Apparatus 1B>

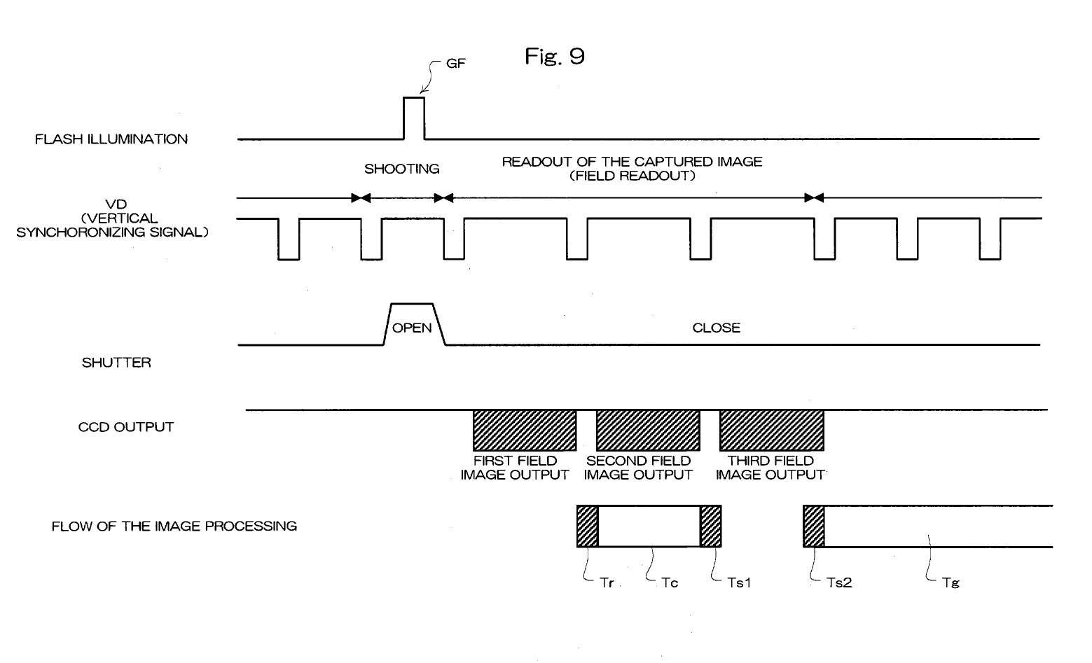

The operation of the image capturing apparatus 1B described below is the operation performed at the time of flash shooting using the flash 69. Although similar to the operation of the image capturing apparatus 1A of the first embodiment shown in the flowchart of FIG. 6, this operation is different therefrom in the shooting operation at step S1. This shooting operation will be described with reference to the timing chart of FIG. 9.

In the shooting operation of the image capturing apparatus 1B, when the shutter button 14 is fully depressed by the user, a light emission operation GF by the flash 69 is performed to perform flash shooting.

In the image capturing apparatus 1B, before the shutter button 14 is fully depressed, the mirror 6 is in the regular position shown in FIG. 8 and no subject image can be obtained by the CCD 2, so that the shutter 12 is closed and no live view display is performed.

In the conventional SLR-type image capturing apparatuses, no optical image of the subject is formed on the CCD 2 before shooting, and the AE and WB correction values used for shooting cannot be predicted. Therefore, after the data of all the pixels is read out from the CCD 2 and stored into the image memory, the AE and WB correction values are calculated based on the image data, so that it is impossible to swiftly perform processing. On the contrary, in the image capturing apparatus 1B of the present embodiment, as shown in FIG. 9, the AE and WB correction values are calculated based on the image of the first field 21 while charges of the CCD 2 are being read out, and are used for the correction processing of the third field 23, so that processing can be swiftly performed.

Moreover, in the conventional image capturing apparatuses, since it is difficult to determine the condition of mixed light in flash shooting, there are cases where correction cannot be appropriately performed by the signal processor 31. On the contrary, in the image capturing apparatus 1B of the present embodiment, since the contents of the correction by the signal processor 31 can be changed in accordance with the image data (image data of the first field) obtained at the time of shooting, image processing can be appropriately performed.

<Third Embodiment>

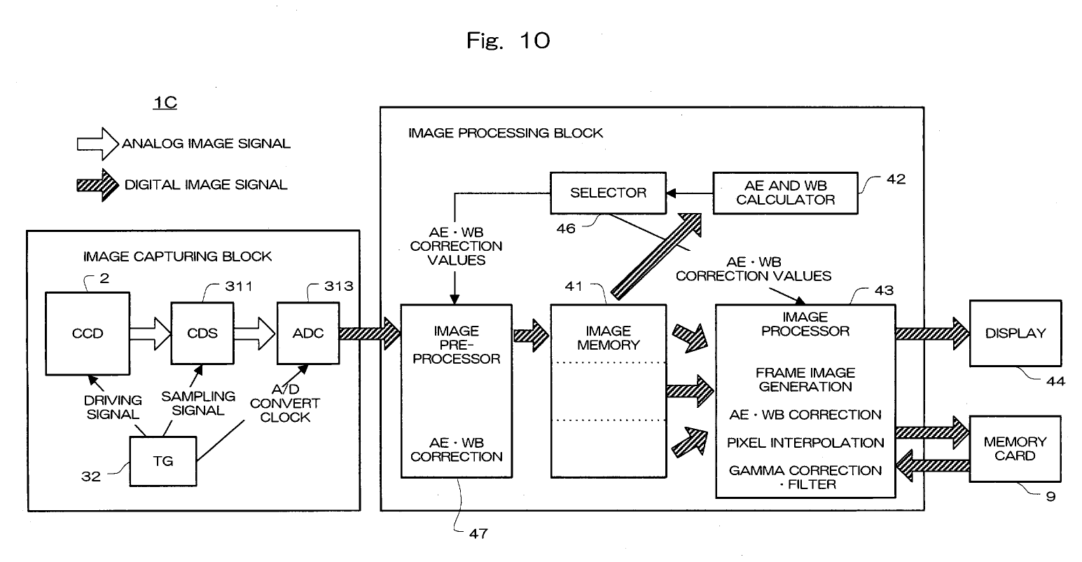

FIG. 10 is a view of assistance in explaining the flow of image signals in an image capturing apparatus 1C according to a third embodiment of the present invention.

Although having a similar structure to that of the image capturing apparatus 1A of the first embodiment shown in FIG. 4, the image capturing apparatus 1C is different therefrom in that an image preprocessor 47 is added instead of the PGA 312 shown in FIG. 4.

The image preprocessor 47, like the PGA 312, corrects the image data of the fields based on the AE and WB correction values calculated by the AE and WE calculator 42 and transmitted from the selector 46. While analog signals are corrected by the PGA 312, in the image preprocessor 47, digital signals transmitted from the ADC 313 are corrected.

The operation of the image capturing apparatus 1C is similar to that of the image capturing apparatus 1A of the first embodiment shown in the flowchart of FIG. 6. However, in the present embodiment, at step S9 of FIG. 6, the AE and WB correction values are set to the image preprocessor 47. Moreover, at step S13, correction by the image preprocessor 47 is performed based on the set AE and WB correction values.

With the above-described operation of the image capturing apparatus 1C, like the first embodiment, image processing can be appropriately and swiftly performed irrespective of changes in shooting condition.

The structure of the image capturing apparatus 1C may be applied to the image capturing apparatus 1B of the second embodiment.

<Modification>

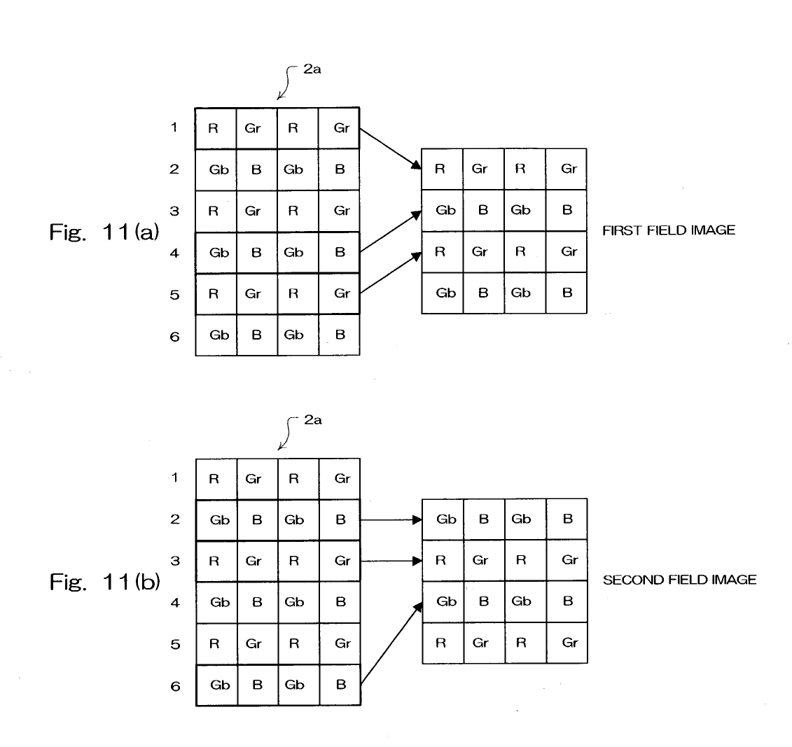

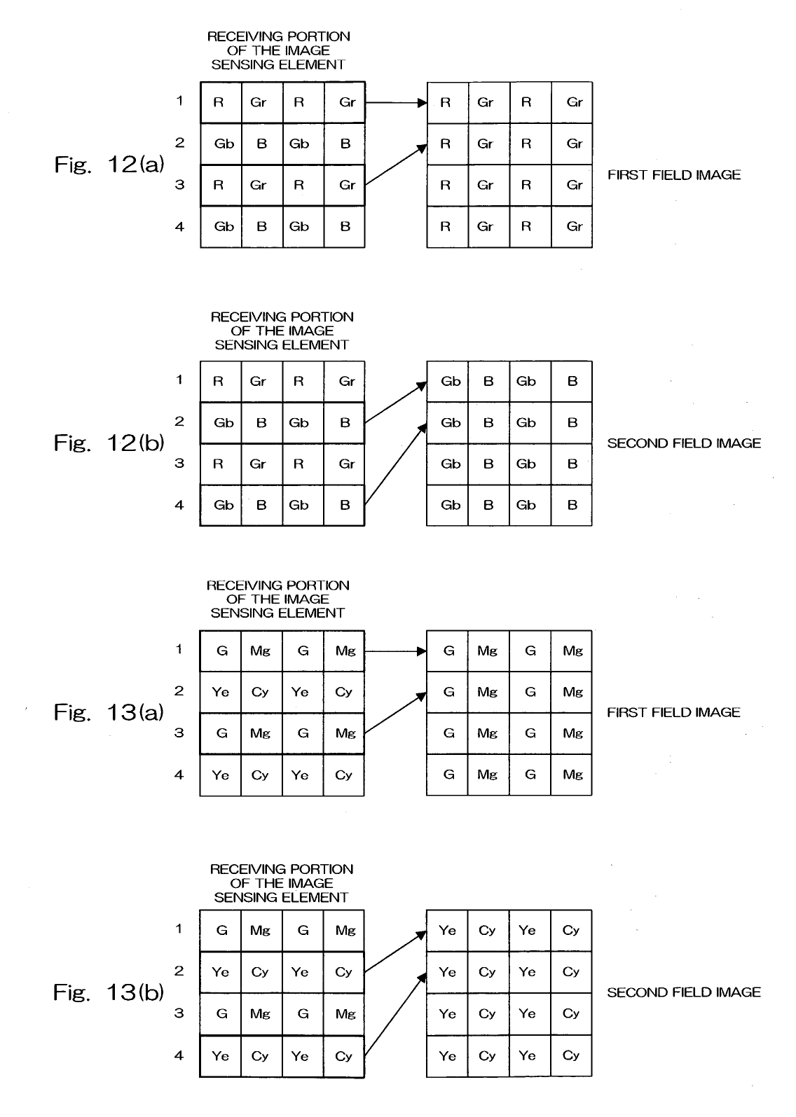

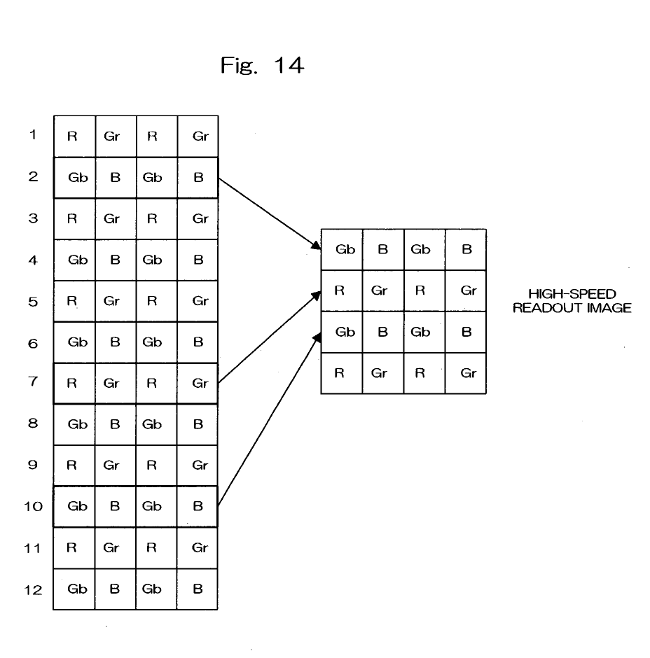

The CCD (image sensor) of the above-described embodiments is not necessarily of a type having three fields, but may be of a type having two fields or four or more fields. For example, in the case of a type having two fields, an image sensor adopting the CCD charge readout method shown in FIGS. 11(a) and 11(b) is used. In this image sensor, a first field image having components of all the colors can be obtained by the readout shown in FIG. 11(a), and a second field image having components of all the colors can be obtained by the readout shown in FIG. 11(b).

According to the present invention, since the number of fields that can be AE-and-WB-corrected in the stage of preprocessing before the image data is stored into the image memory increases as the number of field divisions increases, image processing can be more swiftly performed. When the calculation capability of the AE and WB calculator is high, since the number of fields that can be image-processed in the stage of preprocessing increases, image processing can also be swiftly performed.

In the calculation of the AE and WB correction values in the above-described embodiments, it is not essential that the coefficient k (see the expression (1)) and the coefficient m (see the expression (2)) in the calculation of the weighted averages be different from each other, but they may be the same.

In the above-described embodiments, the AE and WB correction values are calculated in parallel with the readout of the image data of the second field. However, the present invention is not limited thereto. It may be performed to calculate the correction values after or during the readout of the image data of the first field and read out the image data of the second field while correcting it after the calculation of the correction values.

Although the present invention has been fully described by way of examples with referene to the accompanying drawings, it is to be noted that various change and modifications will be apparent to those skilled in the art. Therefore, unless otherwise such changes and modifications depart from the scope of the present invention, they should be construed as being including therein.

What is claimed is:

1. An image capturing apparatus comprising:
an image sensor in which a light receiving portion having a color filter is provided;
a reader for dividing a pixel arrangement of said light receiving portion of said image sensor into a plurality of fields, and for reading out charge signals from said image sensor field by field;
an image processor for performing predetermined image processing on image data corresponding to the charge signals read out by said reader; and
a calculator for calculating a processing parameter used for said predetermined image processing by said image processor based on image data corresponding to the charge signals of a first field from which the charge signals are read out first.

2. An image capturing apparatus according to claim 1, wherein
said charge signals of each field include components of all the colors of said color filter, respectively.

3. An image capturing apparatus according to claim 1, further comprises
a memory for storing said image data, and
before image data corresponding to the charge signals of a predetermined field other than said first field is stored into the memory, said image processor performs image processing based on said processing parameter on said image data of said predetermined field.

4. An image capturing apparatus according to claim 3, wherein
said calculator calculates the processing parameter in parallel with the read out of charge signals of a second field by said reader, and
said image processor performs image processing based on said processing parameter on image data corresponding to the charge signals of a third field.

5. An image capturing apparatus according to claim 4, wherein
after image data corresponding to the charge signals of said first and second field are stored into the memory, said image processor further performs image processing based on the processing parameter on said image data of said first and second field.

6. An image capturing apparatus according to claim 1, wherein
said processing parameter is a brightness correction value of the image data.

7. An image capturing apparatus according to claim 1, wherein
said processing parameter is a white balance correction value of the image data.

8. An image capturing apparatus according to claim 1, wherein
said image data corresponding to the charge signals is analog signals, and
said image processor performs said predetermined image processing on said analog signals.

9. An image capturing apparatus according to claim 1, wherein
said image data corresponding to the charge signals is digital signals, and
said image processor performs said predetermined image processing on said digital signals.

10. An image capturing apparatus according to claim 1, further comprises
a flash for illuminating a subject, and
said image processor and said calculator operate at the time of flash shooting.

11. An image capturing apparatus according to claim 1, further comprising:
a display for displaying an image based on the image data; and
a display controller for displaying on said display an image based on the image data corresponding to the charge signals of the first field read out by the reader.

12. An image capturing apparatus according to claim 11, wherein
said display controller further displays on said display an image based on processed image data by said image processor.

13. A method of image processing of image capturing apparatus comprising the steps of:
generating charge signals by an image sensor in which a light receiving portion having a color filter is provided;
dividing a pixel arrangement of said light receiving portion of said image sensor into a plurality of fields;
reading out charge signals from said image sensor field by field;
calculating a processing parameter used for a predetermined image processing based on image data corresponding to the charge signals of a first field from which the charge signals are read out first; and
performing said predetermined image processing based on said processing parameter on image data corresponding to the charge signals read out.
